(19) United States
(12) Patent Application Publication
(10) Pub. No.: US 2013/0106374 A1
(43) Pub. Date: May 2, 2013

(54) POWER SUPPLY CONTROLLER AND METHOD THEREFOR

(71) Applicant: Alan R. Ball, Gilbert, AZ (US)

(72) Inventor: Alan R. Ball, Gilbert, AZ (US)

(21) Appl. No.: 13/287,862

(22) Filed: Nov. 2, 2011

(51) Int. Cl. G05F 1/46

(52) U.S. Cl. 323/271

(57) ABSTRACT

In one embodiment, a switching power supply circuit includes a power source configured to supply supplemental power to the high side driver in parallel with the bootstrap capacitor.

### BACKGROUND OF THE INVENTION

The present invention relates, in general, to electronics, and more particularly, to semiconductors, structures thereof, and methods of forming semiconductor devices.

In the past, various methods and techniques were utilized to form switching power supply systems that included a high side power transistor and a low side power transistor connected in a stacked or totem-pole or half-bridge configuration. These transistors were utilized to control an output voltage to a desired value. In some applications, the switching power supply system utilized a bootstrap capacitor to provide operating power for operating a high side driver that provided a drive voltage to the gate of the high side power transistor. One example of such a power supply controller is disclosed in U.S. Pat. No. 6,982,574.

During operation, the switching power supply system often would enter a skip-cycle mode that resulted in lowering the frequency of the switching signal used to control the high side and low side transistors. If the frequency decreased sufficiently, the bootstrap capacitor may not be able to supply sufficient power to maintain the operation of the high side driver.

Accordingly, it is desirable to have a method and apparatus for supplying power to the high side driver when the bootstrap capacitor can no longer supply sufficient power.

### BRIEF DESCRIPTION OF THE DRAWINGS

FIG. 1 schematically illustrates an embodiment of a portion of a system

FIG. 1 schematically illustrates an example of a portion of an embodiment of a power supply system that includes an example embodiment of a power supply controller in accordance with the present invention;

FIG. 2 is a graph having plots that illustrate some of the signals of the power supply system of FIG. 1 in accordance with the present invention;

FIG. 3 schematically illustrates an example of an embodiment of another power source that is an alternate embodiment of the power source of FIG. 1 in accordance with the present invention;

FIG. 4 schematically illustrates an example of an embodiment of another power source that is an alternate embodiment of the power source of FIG. 1 in accordance with the present invention;

FIG. 5 schematically illustrates an example of an embodiment of yet another power source that is an alternate embodiment of the power source of FIG. 1 in accordance with the present invention; and

FIG. 6 illustrates an enlarged plan view of a semiconductor device that includes the power supply controller of FIG. 1 in accordance with the present invention.

For simplicity and clarity of the illustration(s), elements in the figures are not necessarily to scale, and the same reference numbers in different figures denote the same elements, unless stated otherwise. Additionally, descriptions and details of well-known steps and elements are omitted for simplicity of the description. As used herein current carrying electrode means an element of a device that carries current through the device such as a source or a drain of an MOS transistor or an emitter or a collector of a bipolar transistor or a cathode or anode of a diode, and a control electrode means an element of the device that controls current through the device such as a gate of an MOS transistor or a base of a bipolar transistor. Although the devices are explained herein as certain N-channel or P-Channel devices, or certain N-type or P-type doped regions, a person of ordinary skill in the art will appreciate that complementary devices are also possible in accordance with the present invention. One of ordinary skill in the art understands that the conductivity type refers to the mechanism through which conduction occurs such as through conduction of holes or electrons, therefore, and that conductivity type does not refer to the doping concentration but the doping type, such as P-type of N-type. It will be appreciated by those skilled in the art that the words during, while, and when as used herein relating to circuit operation are not exact terms that mean an action takes place instantly upon an initiating action but that there may be some small but reasonable delay, such as various propagation delays, between the reaction that is initiated by the initial action. Additionally, the term while means that a certain action occurs at least within some portion of a duration of the initiating action. The use of the word approximately or substantially means that a value of an element has a parameter that is expected to be close to a stated value or position. However, as is well known in the art there are always minor variances that prevent the values or positions from being exactly as stated. It is well established in the art that variances of up to at least ten percent (10%) (and up to twenty percent (20%) for semiconductor doping concentrations) are reasonable variances from the ideal goal of exactly as described. When used in reference to a state of a signal, the term “asserted” means an active state of the signal and the term “negated” means an inactive state of the signal. The actual voltage value or logic state (such as a “1” or a “0”) of the signal depends on whether positive or negative logic is used. Thus, asserted can be either a high voltage or a high logic or a low voltage or low logic depending on whether positive or negative logic is used and negated may be either a low voltage or low state or a high voltage or high logic depending on whether positive or negative logic is used. Herein, a positive logic convention is used, but those skilled in the art understand that a negative logic convention could also be used. The terms first, second, third and the like in the claims or/and in the Detailed Description of the Drawings, as used in a portion of a name of an element are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

### DETAILED DESCRIPTION OF THE DRAWINGS

The present description includes in one embodiment, among other features, a method of forming a power source configured to supply power to the high side driver without switching in parallel with the bootstrap capacitor without switching the low side switch device.

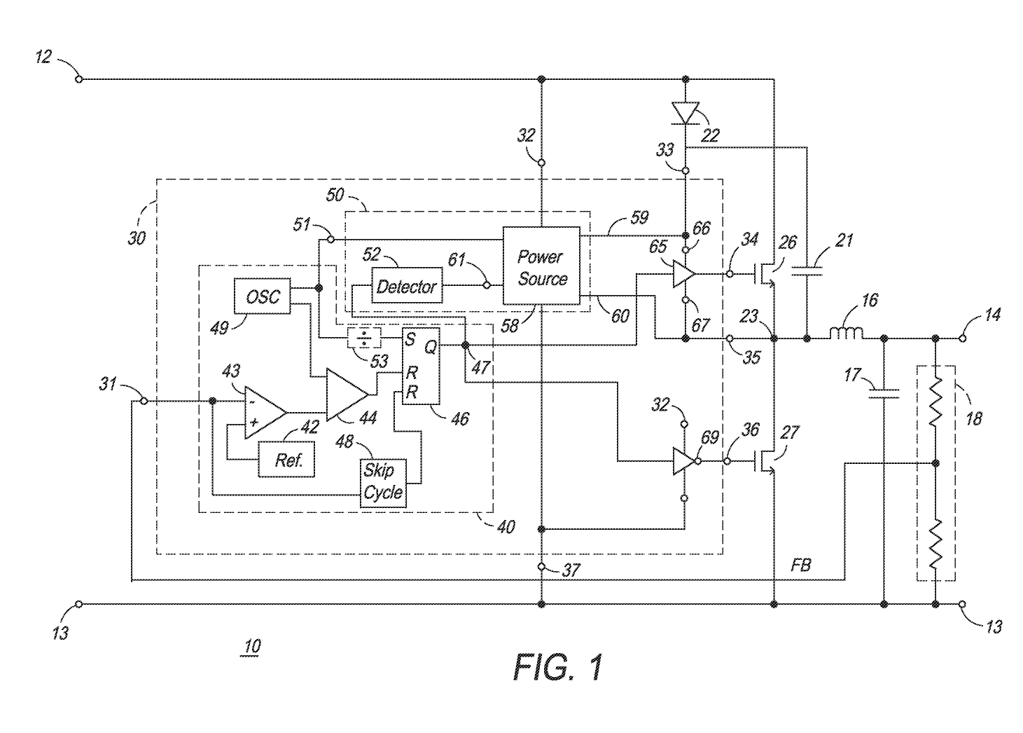

FIG. 1 schematically illustrates an example of a portion of an embodiment of a power supply system 10 that includes an example embodiment of a power supply controller 30. System 10 receives an input voltage between an input terminal 12 and a return terminal 13 and regulates an output voltage to a target value between an output 14 and terminal 13. The output voltage is regulated to the target value within a range of values around the target value. For example, the target value may be three volts (3 v) and the range of values may be plus or minus five percent (5%) around the three volts. System 10 includes a high side switch, illustrated by a transistor 26, and a low side power switch device or low side switch, illustrated by a power transistor 27, that are connected in a half-bridge configuration with a common node 23 formed at a common connection between transistors 26 and 27. Common node 23 is often referred to as a switch node 23. A bootstrap capacitor 21 typically is connected to node 23 and is also connected to receive the input voltage from terminal 12 through a diode 22. An inductor 16 typically is connected between node 23 and output 14, and a filter or smoothing capacitor 17 usually is connected between output 14 and terminal 13. A feedback network 18 typically is connected to output 14 in order to form a feedback (FB) signal that is representative of the value of the output voltage. The FB signal generally is utilized by controller 30 to operate system 10 in a closed loop operational mode.

Controller 30 is a switching power supply controller that includes a voltage input 32 which is configured to receive an input voltage for forming an operating voltage for portions of controller 30. The input voltage is received between input 32 and a common return 37. An FB input 31 of controller 30 is configured to receive the FB signal from network 18. Controller 30 is configured to form a high side drive signal for driving the high side switch on a high side output 34 and is configured to form a low side drive signal for driving the low side switch on a low side output 36. A switch node input 35 is configured to receive the voltage from switch node 23. A boost input 33 is connected to capacitor 21 to receive a boost voltage from capacitor 21. In some embodiments, the high and low side switches may be included within controller 30, thus, outputs 34 and 36 may be internal to controller 30.

Controller 30 typically includes a switching circuit 40 that is configured to receive the FB signal and form a switching control signal to operate the high side switch and to cause the operation of the low side switch in order to regulate the output voltage during a closed loop operational mode of controller 30. In one example embodiment, circuit 40 includes an error amplifier 43, a reference voltage generator or Ref 42, a comparator 44, a pulse width modulated (PWM) latch 46, a skip-cycle detector 48, and an oscillator 49. Circuit 40 may also include an optional divider circuit 53 that may be used to divide the frequency of oscillator 49 to a lower frequency for operating the control loop of controller 30. Those skilled in the art will appreciate that although circuit 40 is illustrated as a leading-edge fixed frequency controller, other types of PWM controllers may be utilized for circuit 40 including a trailing-edge controller, a constant on-time controller, a constant off-time controller, or any other well-known type of PWM controller. Controller 30 also includes a high side driver 65 that is configured to receive a switching control signal from circuit 40 and form a drive signal for controlling the high side switch, for example transistor 26. Controller 30 may also include a low side driver 69 that is configured to form a drive signal controlling the low side switch, for example transistor 27, in response to the switching control signal formed by circuit 40. Those skilled in the art will appreciate that controller 30 typically includes additional logic between circuit 40 and drivers 65 and 69 that may be utilized to control the drive signals in a manner to prevent an overlap of the drive signals formed by drivers 65 and 69.

High side driver 65 includes a power input 66 that is configured to receive the boost voltage from input 33, thus, from capacitor 21, for operating driver 65. Driver 65 also includes a power return 67 that is connected to input 35 to receive the voltage from switch node 23 as a common voltage for operating driver 65. In most configurations, low side driver 69 is configured to receive operating power between input 32 and return 37, although other power sources may be used for operating driver 69. Other elements of circuit 40 generally receive operating power from input 32. Those skilled in the art will appreciate that although driver 69 is illustrated as an inverting driver that receives the switching signal from latch 46, driver 69 may not be an inverting driver and an inverter may be disposed in the sequence prior to driver 69 receiving the switching signal. Additionally, driver 69 may be connected to an inverting output of latch 46 and receive the switching signal from the inverted output, or may receive the switching signal from logic used to prevent overlap of the drive signals from drivers 65 and 69.

Controller 30 further includes a supplemental power system 50 that is configured to also supply supplemental power for operating driver 65. The term supplemental power includes the functionality of power in addition to the power supplied by capacitor 21 from node 23. System 50 includes a supplemental power source 58 which has a power output 59 connected to power input 66 of driver 65, and also has of common output 60 which is connected to power return 67 of driver 65. Source 58 typically includes an enable input 61 configured to receive an enable signal to cause source 58 to form the supplemental voltage and supplemental power. In one embodiment, a control network of system 50 may include a detector 52.

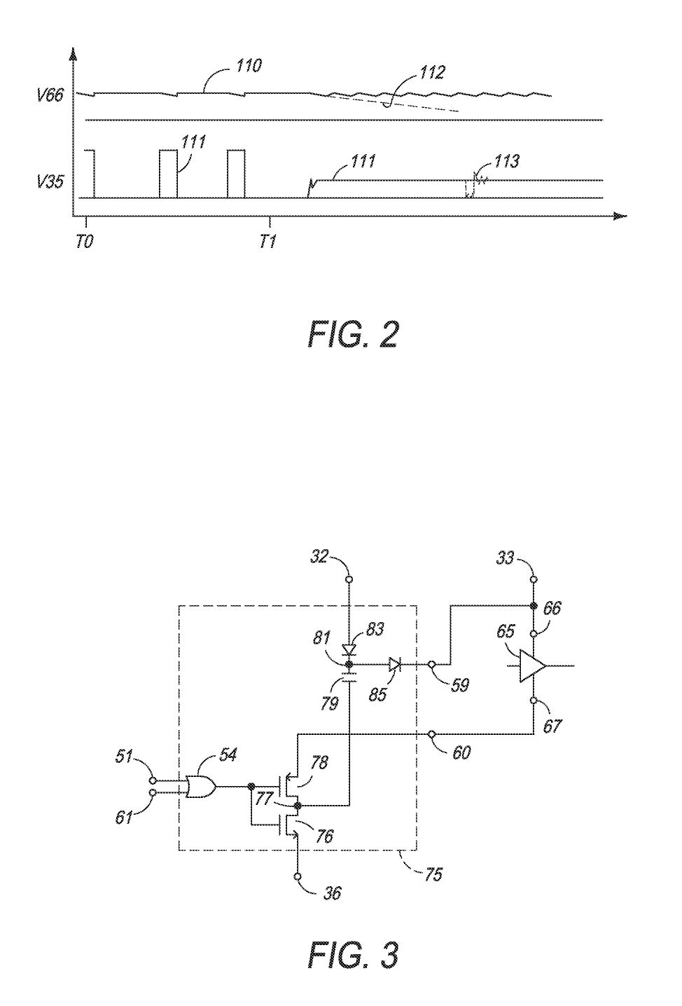

FIG. 2 is a graph having plots that illustrate some of the signals of system 10 during the operation of controller 30. The abscissa indicates time and the ordinate indicates increasing value of the illustrated signal. A plot 110 illustrates the voltage at input 66 of driver 65, and a plot 111 illustrates a voltage on input 35. This description has references to FIG. 1 and FIG. 2.

In normal operation, controller 30 and system 10 operate in a closed loop operational mode with the value of the feedback signal utilized to assist in controlling the duty cycle of transistors 26 and 27 in order to regulate the output voltage to the target value. Those skilled in the art will appreciate that network 18 may have various other configurations including an optical coupler that is used to form the FB signal. Additionally, other types of feedback signals may be used such detecting a value of current supplied by the system instead of or in addition to detecting the value of the output voltage. Such closed loop operating mode is well known to those skilled in the art. During operation, when transistor 27 is turned-on, capacitor 21 is charged from terminal 12 through diode 22. When transistor 27 is turned-off, the voltage stored on capacitor 21 is referenced to the voltage of node 23 to form the boost voltage for operating driver 65. See FIG. 2 between a time T0 and a time T1.

During the operation of system 10, it is possible that the output voltage may increase to a value that causes circuit 40 to begin skipping cycles. Such cycle skipping is well known to those skilled in the art and may also be referred to as operating in a skip-cycle mode. While operating in the skip-cycle mode, transistors 26 and 27 typically are disabled and are not switched for an extended time period that reduces the frequency of the drive signal from node 47. Because transistor 27 is not being switched between the on-state and off-state, capacitor 21 is not recharged. The power used for driver 65 usually causes capacitor 21 to discharge as it supplies current for operating driver 65 and transistor 26. For example, assume that at time T1 (FIG. 2), controller 30 begins operating in a skip-cycle mode. As illustrated by plot 110, the value of the voltage on capacitor 21 begins to discharge. Without system 50, the value of the voltage on capacitor 21 could continue to discharge as illustrated by the dashed line of plot 112. However, system 50 is configured to supply supplemental power to operate driver 65 so that the voltage applied to input 66 does not drop below the value sufficient to operate driver 65. In one embodiment, system 50 is also configured so that the supplemental power supplied to driver 65 also supplies power to capacitor 21 to refresh the charge of capacitor 21. System 50 optionally can be configured to not refresh the voltage of capacitor 21. For example, a blocking diode may be inserted between system 50 and capacitor 21 to prevent current flowing from system 50 to capacitor 21.

In one embodiment as illustrated in FIG. 1, system 50 monitors the switching signal from circuit 40, for example the drive signal supplied to driver 65 from node 47, and enables power source 58 to supply supplemental power to driver 65 in response to the frequency of the drive signal decreasing to a frequency that is less than a first value such that the drive signal has a period that is greater than a first time interval. The time interval usually is selected to be a time that is no greater than a time that would cause the value of the voltage on capacitor 21 to be less than a voltage that would be sufficient to operate driver 65. In another embodiment, system 50 is configured to supply power to the high side driver responsively to an off-time of the low side switch device exceeding the first time interval. In another embodiment, system 50 supplies the power to driver 65 without switching the state of the low side switch, such as transistor 26. In the embodiment illustrated in FIG. 1, detector 52 monitors the period of the drive signal from circuit 40. If the period is greater than a certain value, detector 52 forms an output that enables power source 58 to form a supplemental voltage and supply the supplemental voltage and supplemental power to driver 65. Thus, system 50 is configured to monitor the switching signal, such as the signal on node 47, and supply supplemental power to driver 65 responsively to a frequency of the switching signal being less than a first value, such as a value that would cause the value of the voltage on capacitor 21 to be less than a voltage that would be sufficient to operate driver 65. In one example embodiment, detector 52 may include a re-triggerable one-shot configured to receive the drive signal from the Q output of latch 46 and re-trigger the output of the one-shot to a low state for each transition of the drive signal. If the drive signal remains a given state, low for example, for a time interval that exceeds the period of the one-shot, the output of the one-shot goes high to provide the enable signal to power source 58. In other embodiments, detector 52 may be other configurations that monitor the drive signal and form the time interval, such as a counter that operates from the frequency of oscillator 49.

In one embodiment, system 50 supplies power to driver 65 without causing transistor 27 to switch, for example switch from an on-state to an off-state. Because the low side switch does not switch, the value of the voltage on node 23 remains substantially constant as illustrated by plot 111. If transistor 27 had been switched from an on-state to an off-state, the value of the voltage on node 23 would have transitioned to substantially zero and then switched back which could cause ringing as illustrated by the dashed-line of plot 113. Those skilled in the art will appreciate that since the low side switch device is not switched, supplying power to the high side driver does not cause perturbations on the switch node that can cause changes in the output voltage.

Those skilled in the art will appreciate that the low side switch device may also be a diode instead of transistor 27. In such a configuration, circuit 40 causes the low side switch device to switch instead of forming a drive signal that directly causes the switching of the state of the low side switch device.

In order to facilitate the above described functionality, a clock output of circuit 40 is connected to input 51 of system 50. A switching drive signal output of circuit 40 is connected to an input of detector 52, to an input of driver 65, and to an input of driver 69. An output of detector 52 is connected to enable input 61 of source 58 to. Power output 59 of system 50 is connected to input 66 of driver 65 and to input 33 of controller 30. Common return output 60 of system 50 is connected to return 67 of driver 65 and to input 35 of controller 30. The output of driver 65 is configured to be coupled to output 34 of controller 30 and the output of driver 69 is configured to be coupled to output 36 of controller 30.

FIG. 3 schematically illustrates an example of an embodiment of a power source 75 that is an alternate embodiment of power source 58. Source 75 operates similarly to source 58. Source 75 is configured as a charge pump circuit that, when configured with the other elements of system 50, forms a charge pump system. Source 75 usually includes charge pump transistors 76 and 78, a pump capacitor 79, a blocking diode 83, a diode 85 that is optional, and an enable control circuit illustrated by an OR gate 54. When the enable signal on input 61 is received, transistors 76 and 78 are switched at a rate determined by the frequency of the clock signal received on a clock input 51. In some embodiments, source 75 may operate at the same frequency as circuit 40. In other embodiments oscillator 49 may include multiple outputs at different frequencies such that circuit 40 operates at one frequency and source 75 operates a frequency that is greater than the frequency of circuit 40. In another embodiment, there may be a divider circuit between the output of oscillator 49 and the input of latch 46 that causes latch 46 to receive a lower frequency than the frequency received by source 75. Such an optional divider is illustrated in FIG. 1 in dashed lines as a divider 53.

In operation, assume for example that the clock signal from input 51 enables transistor 76 and disables transistor 78. Enabling transistor 76 pulls node 77 and one plate of capacitor 79 to substantially the value of return 36 thereby allowing capacitor 79 to charge from the input voltage of input 32 through diode 83. When the clock signal changes state, transistor 76 is disabled and transistor 78 is enabled. Enabling transistor 78 connects one plate capacitor 79 to output 60 while the positive charged plate of capacitor 79 is coupled to output 59 through diode 85. This references the voltage on capacitor 79 to the value of switch node 23 such that the voltage from capacitor 79 is referenced to switch node 23 and provides a sufficient voltage for operating driver 65. In one embodiment, this operation also connects capacitor 79 and diode 85 in parallel with capacitor 21 which provides some charge to capacitor 21 thereby increasing the voltage stored on capacitor 21 or refreshing capacitor 21. As long as source 75 remains enabled by the enable signal from input 51, the cycle of charging capacitor 79 and then applying capacitor 79 to supply power to driver 65 continues. Thus, system 50 supplies the supplemental power in the skip-cycle operating mode but not when controller 30 is operating in the normal closed loop operating mode. In another embodiment, system 50 can be continuously enabled to continuously supply the supplemental power to driver 65 and re-charge capacitor 21 even when controller 30 is operating normally in the closed loop operating mode in addition to supplying the supplemental power in the skip-cycle operating mode.

One skilled in the art will also appreciate that in one embodiment the output current of source 75 or any other secondary power source needs only be adequate to provide an output voltage at a current slightly greater than that of the bias current for driver 65 and as such can be designed using very small diodes, capacitor, and transistors, as long as it is used only when transistors 26 and 27 are not switching. The current from source 50 typically is several micro-amperes but the current supplied by capacitor 21 may be ten to one hundred milli-amperes (10-100 mill-amps.). In one example embodiment, the current supplied to driver 65 by capacitor 79, thus by source 75, was about one thousand times less than the current supplied by capacitor 21.

In order to assist in providing the functionality for source 75, a gate of transistor 76 is commonly coupled to a gate of transistor 78 and to an output of gate 54. The source of transistor 76 is connected to return 36. A drain of transistor 76 is commonly connected to node 77, a first terminal of capacitor 79, and a drain of transistor 78. A source of transistor 78 is connected to output 60. A second terminal of capacitor 79 is connected to node 81, a cathode of diode 83, and an anode of diode 85. A cathode of diode 85 is connected to output 59. An anode of diode 83 is connected to input 32. A first input of gate 54 is connected to input 51 and a second input of gate 54 is connected to input 61.

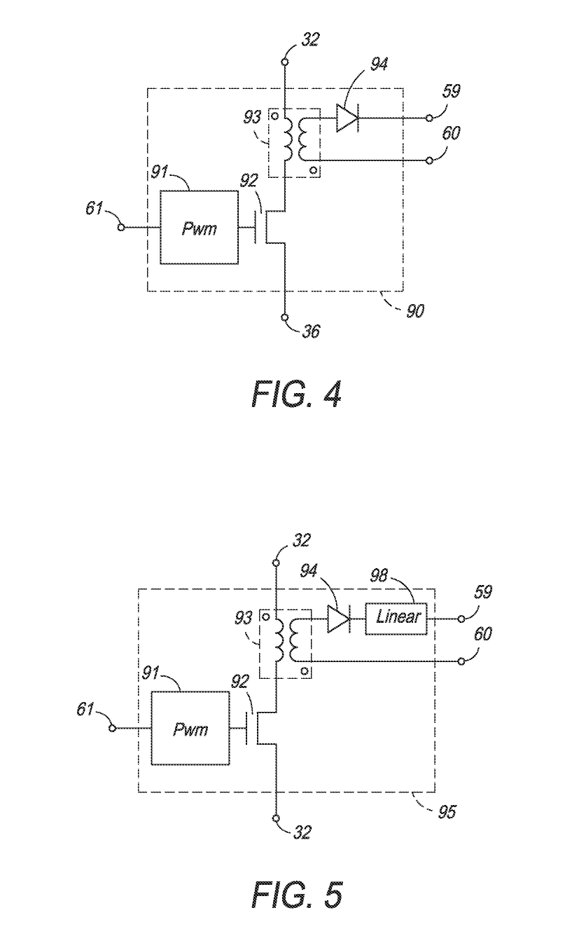

FIG. 4 schematically illustrates an example of a portion of an embodiment of a power source 90 that is another alternate embodiment of power source 58. Power source 90 is a DC-DC converter that receives the voltage from input 32 and forms an output voltage in parallel with the voltage supplied by capacitor 21. In one embodiment, the DC-DC converter is a PWM circuit that includes a PWM controller 91, a power transistor 92, a transformer 93 and a blocking diode 94. Capacitor 21 would function as the storage or filter capacitor of source 90.

FIG. 5 schematically illustrates an example of a portion of an embodiment of a power source 95 that is another alternate embodiment of power source 58. Power source 95 is a modification of power source 90 that includes a linear power supply controller 98 connected to the receive power from diode 94 and regulate the voltage.

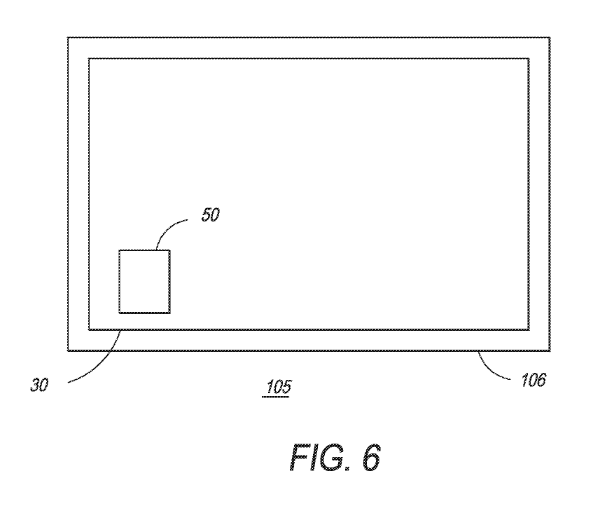

FIG. 6 illustrates an enlarged plan view of a portion of an embodiment of a semiconductor device or integrated circuit 105 that is formed on a semiconductor die 106. System 50 is formed on die 106. Controller 30 typically is formed on die 106 along with system 50. Die 106 may also include other circuits that are not shown in FIG. 6 for simplicity of the drawing.

From all the foregoing one skilled in the art can determinate that according to one embodiment, a power supply circuit for a switching power supply controller comprises: a switching circuit, circuit 40 for example, configured to form a switching control signal used to control a high side switch in order to regulate an output voltage to a target value, the switching control circuit also configured to cause a low side switch device to switch in order to regulate the output voltage to the target value;

a high side driver configured to receive the switching control signal and form a drive signal for the high side switch, the high side driver configured to receive power from a bootstrap capacitor, such as capacitor 21, for operating the high side driver to switch the drive signal between states; and

a charge pump system configured to supply power to the high side driver in parallel with the bootstrap capacitor without switching the low side switch device.

Those skilled in the art will appreciate that another embodiment includes, the charge pump system configured to supply power to the high side driver responsively to the switching circuit not switching the switching control signal for a first time interval, and that another embodiment includes the charge pump system configured to supply power to the high side driver responsively to an off-time of the low side switch device exceeding a first time interval.

In another embodiment, those skilled in the art will understand that the charge pump system does not sense a voltage of the bootstrap capacitor for supplying power to the high side driver, such as determining the time at which to supply supplemental power to the high side driver.

One skilled in the art will understand that one embodiment of a switching power supply circuit includes; a high side driver configured to receive operating power from a bootstrap capacitor;

a control circuit configured to switch the high side driver and to cause a low side switch device to switch in order to regulate an output voltage controlled by the switching power supply controller;

a power source configured to supply supplemental power to the high side driver in parallel with the bootstrap capacitor.

Those skilled in the art understand that another embodiment may include that the power source is configured to supply the supplemental power to the high side driver without causing the low side switch device to switch.

Those skilled in the art understand that another embodiment may include that the power source is configured to supply the supplemental power to the high side driver responsively to an off-time of the low side switch device exceeding a first time interval.

Those skilled in the art also understand that in another embodiment the power source does not sense a voltage of the bootstrap capacitor for supplying power to the high side driver, and will also understand that the power source is one of a charge pump circuit, a DC-DC converter, or a DC-DC converter in combination with a linear regulator.

Those skilled in the art will further appreciate that the power source is configured to decouple the supplemental power from the high side driver responsively to the control circuit changing a state of the high side driver

Those of ordinary skill in the art will further appreciate that a method of forming power source for a switching power supply controller comprises:

configuring the switching power supply controller to form a switching signal used to operate a power switch to regulate an output voltage to a target value wherein a driver circuit is configured to provide a drive signal to drive the power switch;

configuring the driver circuit to receive operating power from a bootstrap capacitor; and

configuring the power source to monitor the switching signal and supply supplemental power to the driver circuit responsively to a frequency of the switching signal being less than a first value.

Those skilled in the art further appreciate that configuring the power source to supply the supplemental power without causing a low side switch device to switch states.

In view of all of the above, it is evident that a novel device and method is disclosed. Those skilled in the art will appreciate that the embodiment of supplying the supplemental power to the driver without causing the low side switch device to switch states, does not cause perturbations on the switch node that can cause changes in the output voltage. This assists in improving the efficiency under light load or skip-cycle operation. The embodiment of supplying the supplemental power to the driver in parallel with the boost capacitor facilitates charging the boost capacitor while operating in the skip-cycle mode which also provide more efficient operation.

While the subject matter of the descriptions are described with specific preferred embodiments and example embodiments, the foregoing drawings and descriptions thereof depict only typical and exemplary embodiments of the subject matter and are not therefore to be considered to be limiting of its scope, it is evident that many alternatives and variations will be apparent to those skilled in the art as long as in one embodiment the supplemental power source supplies power to the high side driver without causing the low side switch device to switch states or change states, and in another embodiment supplies power to the high side driver in parallel with the boost capacitor, and in another embodiment supplies the supplemental power to the high side driver responsively to an off-time of the low side switch device exceeding a first time interval. Some of these are explained hereinbefore. Although controller 30 is illustrated in a buck power supply system application, controller 30 may be used in various other well-known types of power supply systems including a boost system.

As the claims hereinafter reflect, inventive aspects may lie in less than all features of a single foregoing disclosed embodiment. Thus, the hereinafter expressed claims are hereby expressly incorporated into this Detailed Description of the Drawings, with each claim standing on its own as a separate embodiment of an invention. Furthermore, while some embodiments described herein include some but not other features included in other embodiments, combinations of features of different embodiments are meant to be within the scope of the invention, and form different embodiments, as would be understood by those skilled in the art.

1. A power supply circuit for a switching power supply controller comprising:
a switching circuit configured to form a switching control signal used to control a high side switch in order to regulate an output voltage to a target value, the switching circuit also configured to cause a low side switch device to switch in order to regulate the output voltage to the target value;
a high side driver configured to receive the switching control signal and form a drive signal for the high side switch, the high side driver configured to receive power from a bootstrap capacitor for operating the high side driver to switch the drive signal between states; and
a charge pump system configured to supply power to the high side driver in parallel with the bootstrap capacitor without switching the low side switch device.

2. The power supply circuit of claim 1 wherein the charge pump system is configured to supply power to the high side driver responsively to the switching circuit not switching the switching control signal for a first time interval.

3. The power supply circuit of claim 1 wherein the charge pump system is configured to supply power to the high side driver responsively to an off-time of the low side switch device exceeding a first time interval.

4. The power supply circuit of claim 1 wherein the charge pump system does not sense a voltage of the bootstrap capacitor for supplying power to the high side driver.

5. The power supply circuit of claim 1 wherein the charge pump system includes a first switch, a second switch, and a pump capacitor, the first switch configured to couple the pump capacitor to a voltage source to charge the pump capacitor, the second switch configured to couple the pump capacitor to the high side driver to supply power to the high side driver.

6. The power supply circuit of claim 5 further including the charge pump system having a first input for receiving power from the voltage source and the high side driver having a power input for receiving power from the bootstrap capacitor.

7. The power supply circuit of claim 6 further including a first diode coupled between the pump capacitor and the voltage source.

8. The power supply circuit of claim 6 further including a second diode coupled between the pump capacitor and the power input of the high side driver.

9. The power supply circuit of claim 1 wherein the charge pump system and the high side driver are formed on a common semiconductor substrate.

10. The power supply circuit of claim 9 wherein the switching circuit is formed on the common semiconductor substrate.

11. A switching power supply circuit comprising:
a high side driver configured to receive operating power from a bootstrap capacitor;
a control circuit configured to switch the high side driver and to cause a low side switch device to switch in order to regulate an output voltage controlled by the switching power supply controller; and
a power source configured to supply supplemental power to the high side driver in parallel with the bootstrap capacitor.

12. The switching power supply circuit of claim 11 wherein the power source is configured to supply the supplemental power to the high side driver without causing the low side switch device to switch.

13. The switching power supply circuit of claim 11 wherein the power source is configured to supply the supplemental power to the high side driver responsively to an off-time of the low side switch device exceeding a first time interval.

14. The switching power supply circuit of claim 11 wherein the power source does not sense a voltage of the bootstrap capacitor for supplying power to the high side driver.

15. The switching power supply circuit of claim 11 wherein the power source is one of a charge pup system, a DC-DC converter or a DC-DC converter in combination with a linear regulator.

16. The switching power supply circuit of claim 11 wherein the power source is configured to decouple the supplemental power from the high side driver responsively to the control circuit changing a state of the high side driver.

17. A method of forming power source for a switching power supply controller comprising:
configuring the switching power supply controller to form a switching signal used to operate a power switch to regulate an output voltage to a target value wherein a driver circuit is configured to provide a drive signal to drive the power switch;
configuring the driver circuit to receive operating power from a bootstrap capacitor; and
configuring the power source to monitor the switching signal and supply supplemental power to the driver circuit responsively to a frequency of the switching signal being less than a first value.

18. The method of claim 17 wherein configuring the power source includes configuring the power source to supply the supplemental power without causing a low side switch device to switch states.

19. The method of claim 17 wherein configuring the power source includes configuring the power source to supply the supplemental power in parallel with the bootstrap capacitor.

20. The method of claim 17 wherein configuring the power source includes configuring a charge pump system to supply the supplemental power to the driver circuit.
